(19) United States
(12) Patent Application Publication
(10) Pub. No.: US 2014/0157118 A1
(43) Pub. Date: Jun. 5, 2014

(54) INFORMATION PROCESSING APPARATUSES, NON-TRANSITORY COMPUTER READABLE MEDIUM, AND INFORMATION PROCESSING METHOD

(71) Applicant: FUJI XEROX CO., LTD., Tokyo (JP)

(72) Inventors: Yoshihisa MATSUO, Kanagawa (JP); Takeshi Kunimasa, Kanagawa (JP); Takenori Matsuo, Kanagawa (JP); Toshiyuki Komoda, Kanagawa (JP); Norihiro Wada, Kanagawa (JP); Naoki Okamoto, Kanagawa (JP); Koji Bito, Kanagawa (JP)

(21) Appl. No.: 13/909,651

(22) Filed: Jun. 4, 2013

(30) Foreign Application Priority Data
Dec. 5, 2012 (JP) 2012-266793

(51) Int. Cl. G06F 17/24

(52) U.S. Cl. CPC G06F 17/24
USPC 715/255

(57) ABSTRACT

An information processing apparatus includes a display, a detector, a display controller, a bookmark-information generation unit, and a switch command generation unit. The detector detects a touch of a finger on a screen of the display. The display controller makes a page image be displayed on the screen and executes, upon receiving a switch command, switch processing in which switching to another page image is performed. The bookmark-information generation unit generates, in a case where the switch processing is executed in a state in which a touch of the finger is being detected on a page image on the screen, bookmark information that includes identification information of the page image. The switch command generation unit generates a switch command used to perform switching to a page image specified by the bookmark information in a case where the touch of the finger is no longer detected.

### CROSS-REFERENCE TO RELATED APPLICATIONS

This application is based on and claims priority under 35 USC 119 from Japanese Patent Application No. 2012-266793 filed Dec. 5, 2012.

### BACKGROUND

1. Technical Field

The present invention relates to an information processing apparatus, a non-transitory computer readable medium, and an information processing method.

2. Summary

According to an aspect of the invention, there is provided an information processing apparatus including a display, a detector, a display controller, a bookmark-information generation unit, and a switch command generation unit. The detector detects a touch of a finger on a screen of the display. The display controller makes a page image selected from plural page images be displayed on the screen and executes, upon receiving a page switch command, page switch processing in which a page image displayed on the screen is switched to another page image. The bookmark-information generation unit generates, in a case where the page switch processing is executed in a state in which a touch of the finger is being detected on the screen on which a page image is displayed, bookmark information that includes identification information of the page image, which is displayed on the screen before execution of the page switch processing. The switch command generation unit generates a page switch command used to switch a page image displayed on the screen to a page image specified by the bookmark information in a case where the touch of the finger is no longer detected.

### BRIEF DESCRIPTION OF THE DRAWINGS

An exemplary embodiment of the present invention will be described in detail based on the following figures, wherein:

FIG. 1 is a diagram illustrating an example of the structure of an information processing apparatus;

FIG. 2 is a diagram illustrating an example of a page database;

FIG. 3 is a diagram illustrating an example of a bookmark database;

FIG. 4 is a diagram illustrating an example of screen display;

FIG. 5 is a diagram illustrating an example of screen display;

FIG. 6 is a diagram illustrating an example of screen display;

FIG. 7 is a diagram illustrating an example of screen display;

FIG. 8 is a diagram illustrating an example of screen display;

FIG. 9 is a diagram illustrating an example of a functional configuration of the information processing apparatus;

FIG. 10 is a diagram illustrating an example of operation of the information processing apparatus;

FIG. 11 is a diagram illustrating an example of operation of the information processing apparatus;

FIG. 12 is a diagram illustrating an example of operation of the information processing apparatus;

FIG. 13 is a diagram illustrating an example of operation of the information processing apparatus;

FIG. 14 is a diagram illustrating an example of operation of the information processing apparatus; and

FIG. 15 is a diagram illustrating an example of operation of the information processing apparatus.

### DETAILED DESCRIPTION

An information processing apparatus, a non-transitory computer readable medium, and an information processing method according to an exemplary embodiment will be described with reference to the drawings.

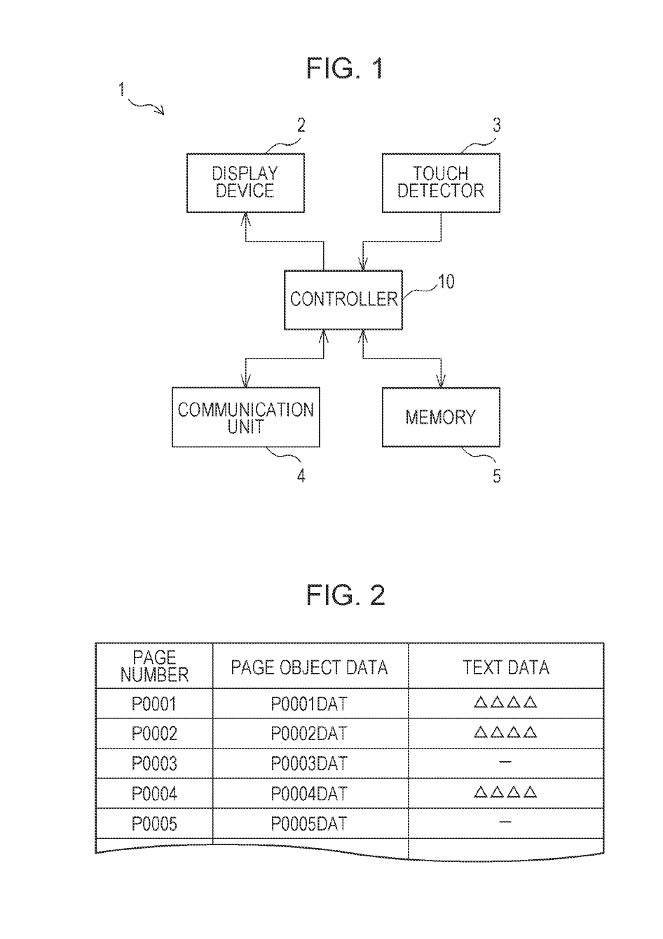

FIG. 1 is a diagram illustrating an example of the structure of an information processing apparatus 1. The information processing apparatus 1 includes a controller 10, a display device 2, a touch detector 3, a communication unit 4, and a memory 5. The information processing apparatus 1 is realized by using, for example, a mobile terminal such as a tablet computer.

The controller 10 includes, for example, a computation unit such as a central processing unit (CPU) and a memory such as a random-access memory (RAM), and executes information processing in accordance with a program. The program may be provided from a computer-readable information storage medium such as a compact disc read-only memory (CD-ROM) or may be provided via communication lines such as the Internet.

The display device 2 is, for example, a flat panel display such as a liquid crystal display (LCD) or an organic electroluminescence display (OED). The touch detector 3 is, for example, a touch screen that may be arranged on the display surface of the display device 2. The touch detector 3 detects a touch of a user in a predetermined area on the screen. Such a touch of a user is an example of contact.

The communication unit 4 is a device used to perform communication with another apparatus via a communication network. The communication unit 4 transmits data received from another apparatus to the controller 10, and transmits data received from the controller 10 to another apparatus.

The memory 5 is, for example, a solid-state drive (SSD). A database that the controller 10 may access is configured in the memory 5. Note that the database may be configured in an apparatus other than the information processing apparatus 1.

The information processing apparatus 1 realizes an electronic document viewing function. A page object (an example of a page image) that presents an electronic document is displayed on the screen of the display device 2 of the information processing apparatus 1. In the information processing apparatus 1, an operation or the like to turn a page is accepted by the touch detector 3. Moreover, the information processing apparatus 1 generates bookmark information in order to make returning to a desired page easier. Details of the bookmark information will be described below.

Databases configured in the memory 5 include a page database and a bookmark database.

FIG. 2 is a diagram illustrating an example of a page database. The page database manages data of page objects in units of pages. The page database includes fields of “page number”, “page object data”, and “text data”. The field “page number” contains page numbers, each of which is identification information of a corresponding page object. For each of the page numbers, the field “page object data” contains the data name of image data of the page object corresponding to the page number and the field “text data” contains text included in the page object corresponding to the page number.

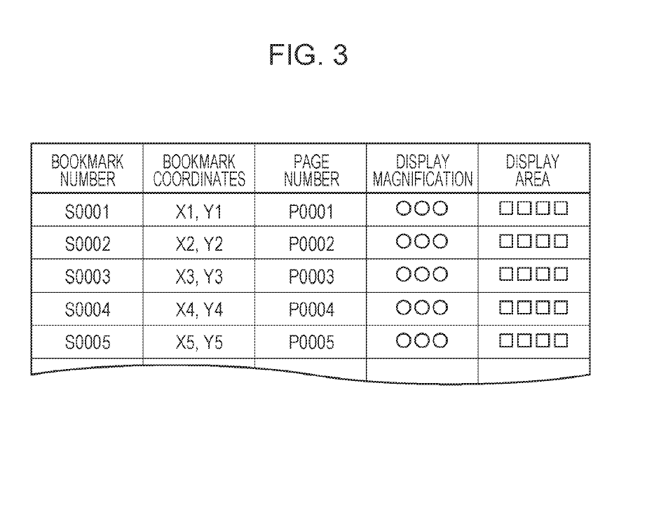

FIG. 3 is a diagram illustrating an example of a bookmark database. The bookmark database manages pieces of bookmark information generated at the time when documents are viewed. The bookmark database includes fields of “bookmark number”, “bookmark coordinates”, “page number”, “display magnification”, and “display area”. The field “bookmark number” contains bookmark numbers, each of which is identification information of a corresponding piece of bookmark information. For each of the bookmark numbers, the field “bookmark coordinates” contains the coordinates of a point that is being touched (hereinafter simply referred to as “touch coordinates”) that are related to the piece of bookmark information corresponding to the bookmark number. The field “page number” contains the page number of a page object for which the piece of bookmark information corresponding to the bookmark number is generated. The field “display magnification” contains a display magnification of a screen when the piece of bookmark information corresponding to the bookmark number is generated. The field “display area” contains a display area of a screen when the piece of bookmark information corresponding to the bookmark number is generated.

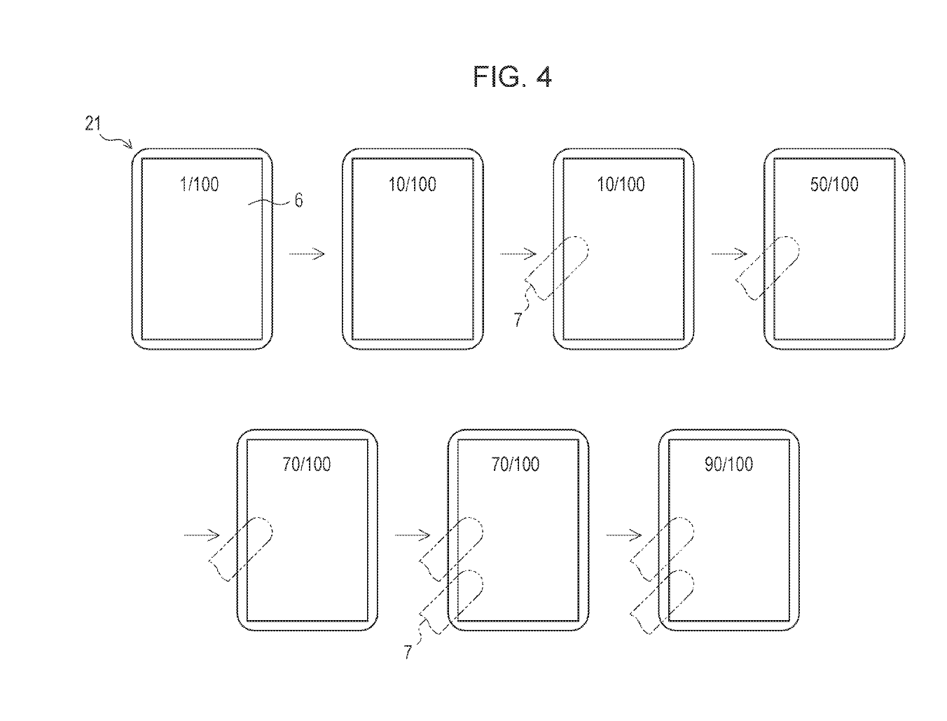

In the following, an example of screen display for the information processing apparatus 1 will be described. FIGS. 4 to 8 are diagrams illustrating examples of screen display. In these figures, numbers shown in a page object 6 represent page numbers.

FIG. 4 is a diagram illustrating an example of screen display to describe generation of bookmark information. One page object 6 selected from plural page objects is displayed on a screen 21. When a user performs a page-turn operation, the page object 6 displayed on the screen 21 switches to the next page object in page order as though the page were being turned. Such a page-turn operation is accepted when a swipe operation in which a position being touched (hereinafter may also referred to as a “touch position”) moves to a left or right side of a detection area of the touch detector 3 at a predetermined speed or faster is detected in the detection area of the touch detector 3. The page-turn operation is not limited this. The page-turn operation may be accepted, for example, when a mechanical button provided in the information processing apparatus 1 is operated or when an accelerometer provided in the information processing apparatus 1 detects tilting of the information processing apparatus 1.

Bookmark information is generated when a user performs an operation described below. For example, bookmark information is generated when a page-turn operation is performed in a state in which a bookmark area set in the screen 21 is being touched with a finger 7. In the present exemplary embodiment, the bookmark area is set to be the entirety of the screen 21. That is, the entirety of the detection area of the touch detector 3 is used as the bookmark area. The bookmark area is not limited this. The bookmark area may be set to be both or one of left and right side portions of the screen 21. In the example illustrated in FIG. 4, bookmark information is generated for the page objects 6 of pages 10 and 70. That is, when the page object 6 of page 10 is displayed on the screen 21, the screen 21 is touched with the finger 7 and a page-turn operation is performed in a state in which the screen 21 is being touched with the finger 7. Consequently, bookmark information is generated for the page object 6 of page 10. The same applies to the page object 6 of page 70. Moreover, there may be a case in which plural pieces of bookmark information are generated. For example, when a first page object is displayed on the screen 21, the screen 21 is touched with a finger 7 and a page-turn operation is performed in a state in which the screen 21 is being touched with the finger 7. Consequently, bookmark information is generated for the first page object. When a second page object is displayed on the screen 21, the screen 21 is touched with a finger 7 that is different from the finger 7 used for the first page object and a page-turn operation is performed in a state in which the screen 21 is being touched with the finger 7 that is different from the finger 7 used for the first page object. Consequently, bookmark information is generated for the second page object.

Note that bookmark information may be generated not only when a page-turn operation is performed in a state in which the bookmark area is being touched with a finger 7 but also when a touch satisfies a predetermined condition. The predetermined condition may be a case where a touch position is in a predetermined area such as on a page object or a case where a position is being touched for more than a predetermined time period.

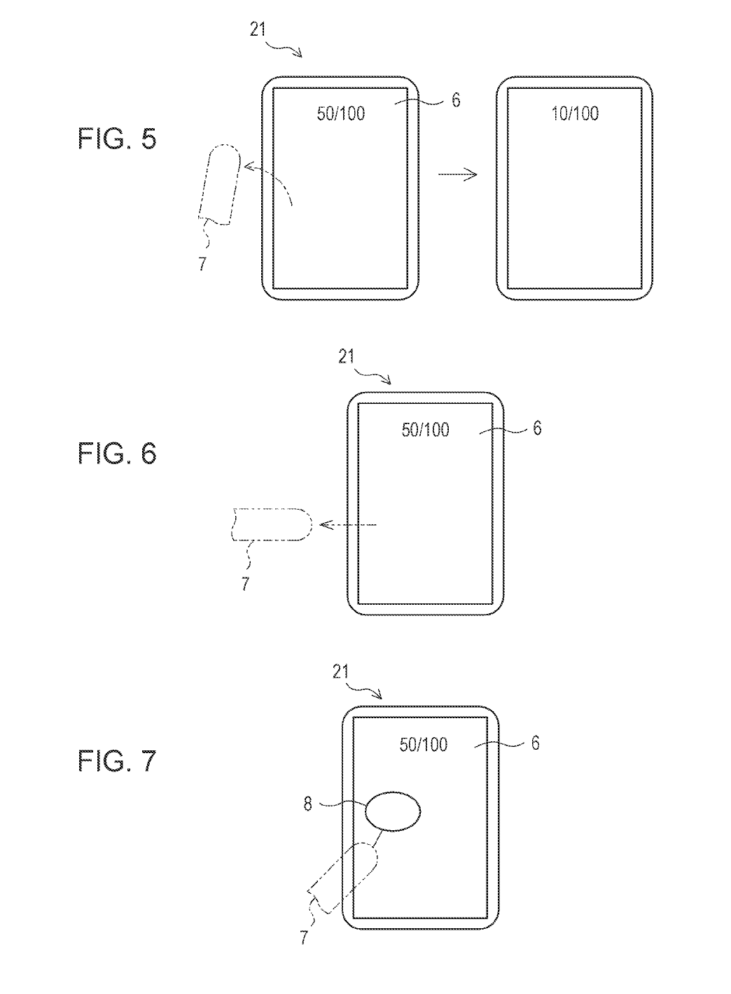

FIG. 5 is a diagram illustrating an example of screen display to describe a page return operation based on bookmark information. A page return operation is performed when a touch performed on the screen 21 ends, that is, when the finger 7 stops touching the screen 21. In a page return operation, the page object 6 displayed on the screen 21 is switched to a page object 6 specified by bookmark information. In the example illustrated in FIG. 5, a display target of the screen 21 returns to the page object 6 of page 10, which corresponds to bookmark information. That is, in the case where bookmark information has been generated for the page object 6 of page 10 and the page object 6 of another page is displayed on the screen 21, when the finger 7 stops touching the screen 21, the display target of the screen 21 is switched to the page object 6 of page 10, which corresponds to the bookmark information.

FIG. 6 is a diagram illustrating an example of screen display to describe deletion of bookmark information. Deletion of bookmark information is realized when a touch position on the screen 21 has moved to a side of the screen 21, that is, when a user slides a finger 7 touching the screen 21, from a side of the screen 21 in a direction toward the outside of the screen 21.

FIG. 7 is a diagram illustrating an example of screen display to describe display of a mark 8. Display of a mark 8 is realized when a touch position has moved by a predetermined distance on the screen 21, that is, when a user has moved a finger 7 touching the screen 21 by the predetermined distance. A mark 8 is, for example, displayed near a finger 7 touching the screen 21. On a mark 8, a reduced image or text of a page object 6 corresponding to bookmark information is displayed.

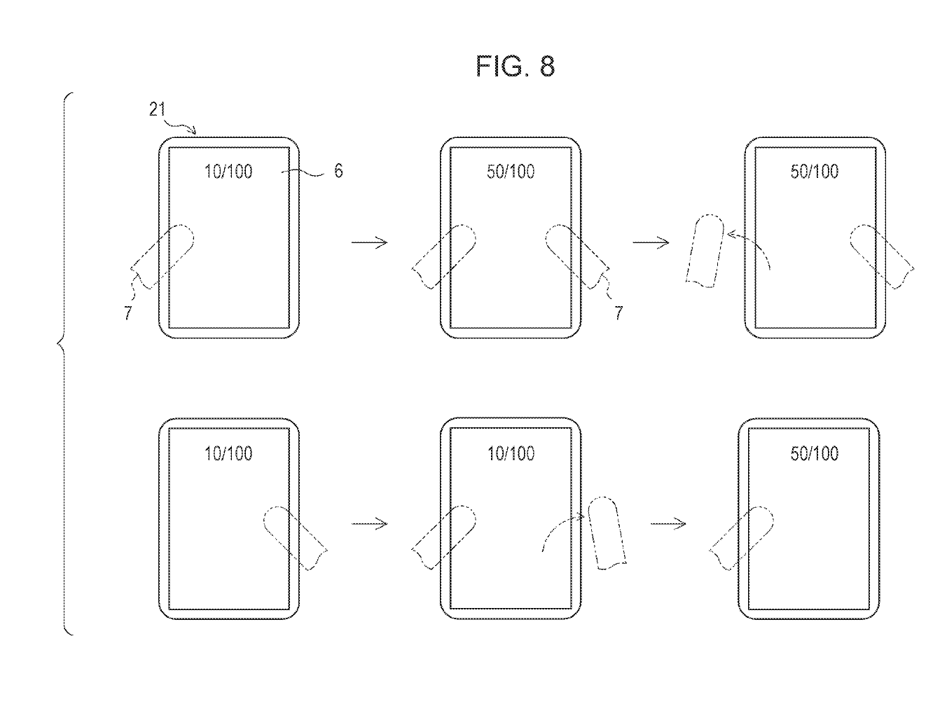

FIG. 8 is a diagram illustrating an example of screen display to describe generation of bookmark information and an example of a page return operation. For example, before a user stops touching the screen 21 with a finger 7 of one hand, the user touches the screen 21 with a finger 7 of the other hand. In this state, when the user stops touching the screen 21 with the finger 7 of the one hand, bookmark information is newly generated for the page object 6 of the page that is being displayed at that time on the screen 21. In the example illustrated in FIG. 8, bookmark information is generated for the page object 6 of page 10. Then, in the case where the bookmark information has been generated for the page object 6 of page 10 and the page object 6 of page 50 is displayed on the screen 21, a user touches the screen 21 with a finger 7 of the right hand before the user stops touching the screen 21 with a finger 7 of the left hand so as to perform a page return operation. While the user is touching the screen 21 with the finger 7 of the right hand, the user stops touching the screen 21 with the finger 7 of the left hand, and consequently, the display target of the screen 21 returns to the page object 6 of page 10 and bookmark information is newly generated for the page object 6 of page 50. Furthermore, the user touches the screen 21 with a finger 7 of the left hand before the user stops touching the screen 21 with the finger 7 of the right hand so as to perform a page return operation. While the user is touching the screen 21 with the finger 7 of the left hand, the user stops touching the screen 21 with the finger 7 of the right hand, and consequently, the display target of the screen 21 returns to the page object 6 of page 50 and bookmark information is newly generated for the page object 6 of page 10. By performing such operations, the user may view the page objects 6 of pages 10 and 50 repeatedly and alternately.

In the following, a structure that realizes the above-described screen display will be described.

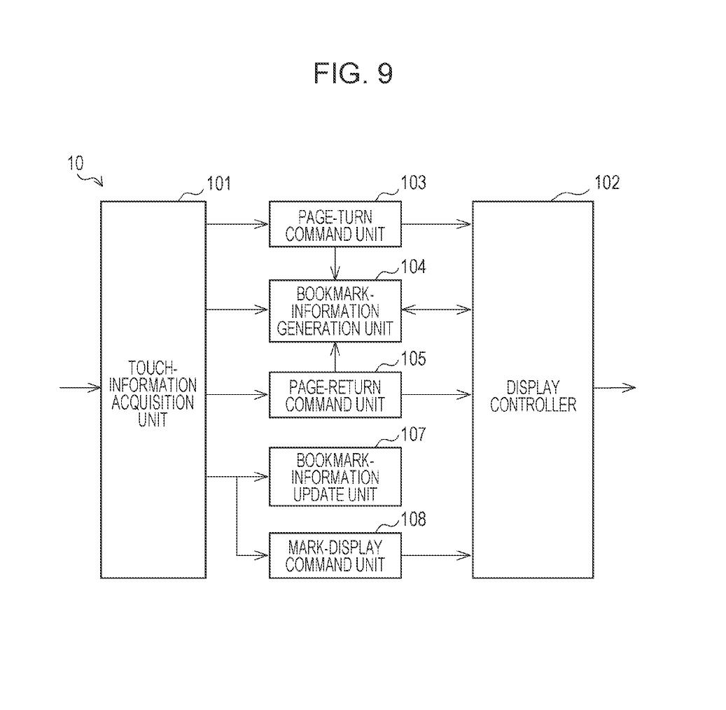

FIG. 9 is a diagram illustrating an example of a functional configuration of the information processing apparatus 1. FIG. 9 is a functional block diagram mainly illustrating functions related to the present exemplary embodiment from among the functions realized by the information processing apparatus 1. The controller 10 of the information processing apparatus 1 includes a touch-information acquisition unit 101, a display controller 102, a page-turn command unit 103, a bookmark-information generation unit 104, a page-return command unit 105, a bookmark-information update unit 107, and a mark-display command unit 108.

The individual units described above are realized by the controller 10 of the information processing apparatus 1, the controller 10 executing processing in accordance with programs. Moreover, the controller 10 may access the page database and the bookmark database configured in the memory 5.

The touch-information acquisition unit 101 acquires touch information detected by the touch detector 3. For example, the touch-information acquisition unit 101 outputs touch information to the page-turn command unit 103 when a swipe event occurs. A swipe event is an event in which a touch position moves toward the left or right side of the screen 21 at a predetermined speed or faster. Moreover, the touch-information acquisition unit 101 outputs touch information to the bookmark-information generation unit 104 when a down-event occurs. A down-event is an event in which a finger 7 is placed on the screen 21. Moreover, the touch-information acquisition unit 101 outputs touch information to the page-return command unit 105 when an up-event occurs. An up-event is an event in which a finger 7 stops touching the screen 21. Moreover, the touch-information acquisition unit 101 outputs touch information to the bookmark-information update unit 107 and the mark-display command unit 108 when a move event (except for the swipe event) occurs. A move event is an event in which a touch position moves.

The display controller 102 reads data of a page object 6 selected from plural page objects 6 from the page database and makes the page object 6 be displayed on the screen 21. Moreover, the display controller 102 changes a display magnification of or a display area of a page object 6 to be displayed on the screen 21 in accordance with an operation input performed by a user.

Upon receiving touch information regarding a swipe-event from the touch-information acquisition unit 101, the page-turn command unit 103 generates a page-turn command (an example of page switch commands) for switching a page object 6 displayed on the screen 21 to a page object 6 to be displayed on the screen 21 and outputs the page-turn command to the display controller 102. Moreover, the page-turn command unit 103 notifies the bookmark-information generation unit 104 that the page-turn command unit 103 has output a page-turn command.

Upon receiving a page-turn command, the display controller 102 switches a page object 6 displayed on the screen 21 to a page object 6 to be displayed on the screen 21. For example, in the case where a page-turn command is a command that instructs display of the next page, the display controller 102 switches the display target of the screen 21 to the page object 6 of the next page. In contrast, in the case where a page-turn command is a command that instructs display of the preceding page, the display controller 102 switches the display target of the screen 21 to the page object 6 of the preceding page. Note that the display controller 102 may make animation in which a page is turned be displayed when a page object 6 displayed on the screen 21 is switched to a page object 6 to be displayed on the screen 21.

While receiving touch information regarding a down-event from the touch-information acquisition unit 101, when the bookmark-information generation unit 104 is notified that a page-turn command has been output from the page-turn command unit 103, the bookmark-information generation unit 104 generates bookmark information and stores the bookmark information in the bookmark database. Here, the bookmark-information generation unit 104 acquires the page number, the display magnification, and the display area of the page object 6 that is being displayed on the screen 21 before output of the page-turn command from the display controller 102 and generates bookmark information that includes these pieces of data. Moreover, the bookmark-information generation unit 104 generates bookmark information that includes the touch coordinates of a down-event as bookmark coordinates.

Note that, while receiving touch information regarding a down-event from the touch-information acquisition unit 101, when the bookmark-information generation unit 104 is notified that a page-return command has been output from the page-return command unit 105, the bookmark-information generation unit 104 also generates bookmark information and stores the bookmark information in the bookmark database.

The page-return command unit 105 is an example of a switch command generation unit. Upon receiving touch information regarding an up-event from the touch-information acquisition unit 101, the page-return command unit 105 generates a page-return command (an example of the page switch commands) for switching the display target of the screen 21 to a page object 6 specified by bookmark information and outputs the page-return command to the display controller 102. Here, bookmark information according to a page-return command is bookmark information that includes the touch coordinates of an up-event as bookmark coordinates. Moreover, the page-return command unit 105 notifies the bookmark-information generation unit 104 that the page-return command unit 105 has output a page-return command.

Upon receiving a page-return command, the display controller 102 reads bookmark information according to the page-return command from the bookmark database and switches the display target of the screen 21 to the page object 6 of the bookmark number included in the bookmark information. Moreover, the display controller 102 makes the page object 6 to be displayed on the screen 21 after switching be displayed at the display magnification and in the display area included in the bookmark information.

Upon receiving touch information regarding a move event from the touch-information acquisition unit 101, the bookmark-information update unit 107 acquires the coordinates of a destination to which the touch position according to bookmark information has moved. The bookmark-information update unit 107 updates the bookmark information stored in the bookmark database with the acquired coordinates of the destination, which are new bookmark coordinates. Moreover, in the case where a destination to which the touch position according to bookmark information has moved has reached a predetermined position, for example, a side of the screen 21, the bookmark-information update unit 107 deletes the bookmark information.

In the case where the mark-display command unit 108 has received touch information regarding a move event from the touch-information acquisition unit 101 and a movement distance of the touch position according to bookmark information has reached a predetermined distance, the mark-display command unit 108 outputs a mark display command to the display controller 102, the mark display command being a command for displaying a mark 8 that includes information of the page object 6 specified by the bookmark information.

Upon receiving a mark display command, the display controller 102 reads information of the page object 6 specified by the bookmark information from the page database and makes a mark 8 that includes the information be displayed on the page object 6. A mark 8 is displayed, for example, near the touch position according to bookmark information. Moreover, the mark 8 includes a reduced image of the page object 6 or text. For example, there may be a case where plural pieces of bookmark information are generated. In this case, for each of the plural pieces of bookmark information, a mark 8 is displayed near the touch position according to the piece of bookmark information.

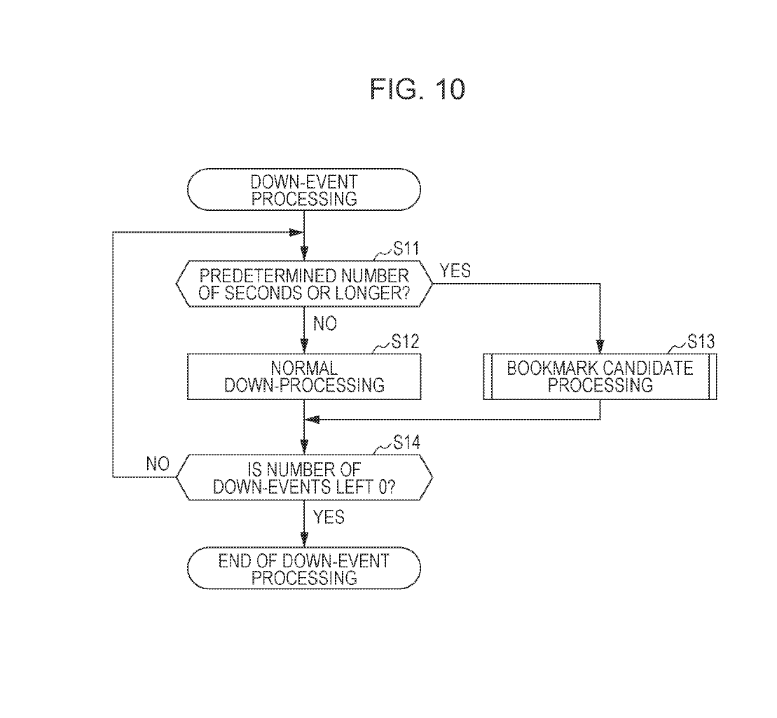

Next, operation of the information processing apparatus 1 will be described. FIGS. 10 to 15 are diagrams illustrating an example of operation of the information processing apparatus 1. The operation is realized by the controller 10 of the information processing apparatus 1, the controller 10 executing processing in accordance with programs.

FIG. 10 is a diagram illustrating an example of operation of the information processing apparatus 1 to describe down-event processing. The controller 10 starts down-event processing when a down-event occurs.

In step S11, the controller 10 determines whether or not a touch has continued for a predetermined number of seconds or longer. When the touch has continued for less than the predetermined number of seconds (NO in step S11), the procedure proceeds to step S12. In step S12, the controller 10 executes normal down-processing. Normal down-processing is processing in which, for example, an object or menu displayed on the screen 21 is selected, or the like. In contrast, when the touch has continued for the predetermined number of seconds or longer (YES in step S11), the procedure proceeds to step S13. In step S13, the controller 10 executes bookmark candidate processing, which will be described below. The controller 10 performs the steps S11 to S13 for all down-events. When the number of down-events left becomes zero, the controller 10 ends the down-event processing (in step S14).

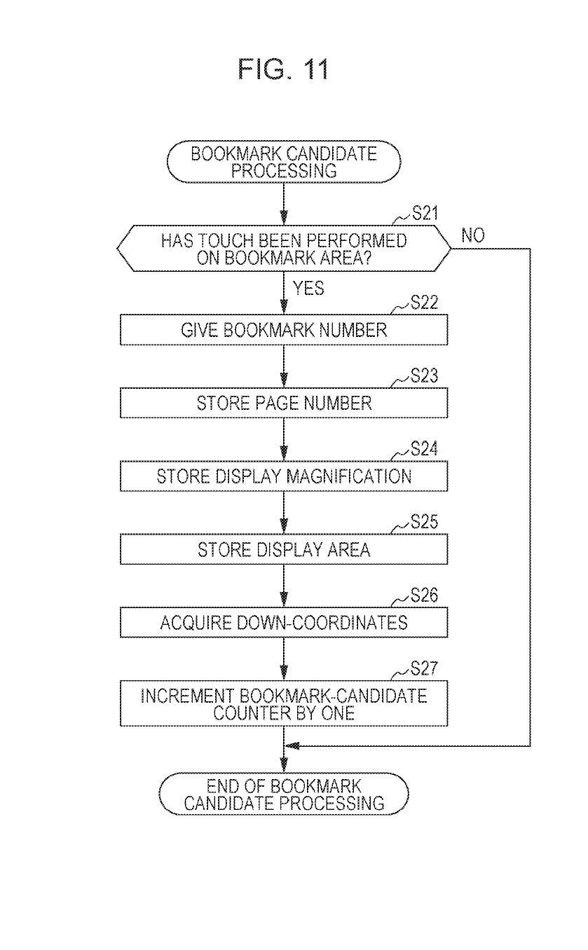

FIG. 11 is a diagram illustrating an example of operation of the information processing apparatus 1 to describe bookmark candidate processing. The controller 10 starts bookmark candidate processing in step S13 of the above-described down-event processing.

In step S21, the controller 10 determines whether or not a touch has been performed on a bookmark area. When a touch has been performed on the bookmark area (YES in step S21), the procedure proceeds from step S22 to step S27. In steps S22 to S27, the controller 10 generates a bookmark candidate. That is, in step S22, the controller 10 gives a bookmark candidate a bookmark number. In step S23, the controller 10 acquires the page number of a page object 6 that is being displayed on the screen 21 and stores the page number in such a manner that the page number is related to the bookmark candidate. In step S24, the controller 10 acquires the display magnification of the page object 6 that is being displayed on the screen 21 and stores the display magnification in such a manner that the display magnification is related to the bookmark candidate. In step S25, the controller 10 acquires the display area of the page object 6 that is being displayed on the screen 21 and stores the display area in such a manner that the display area is related to the bookmark candidate. In step S26, the controller 10 acquires down-coordinates that represent a touch position at which the touch has been performed and stores the down-coordinates in such a manner that the down-coordinates are related to the bookmark candidate. In step S27, the controller 10 increments a bookmark-candidate counter by one. Then, the bookmark candidate processing ends.

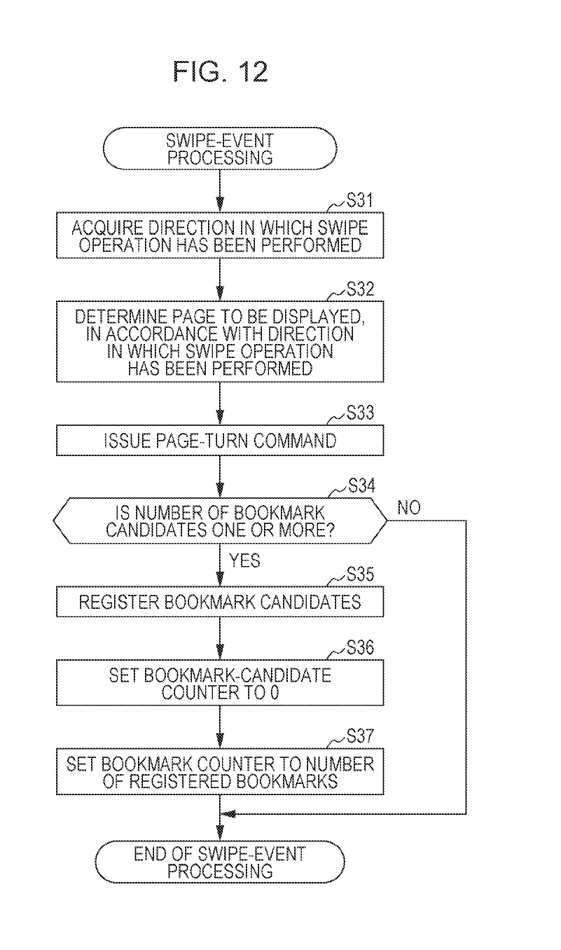

FIG. 12 is a diagram illustrating an example of operation of the information processing apparatus 1 to describe swipe-event processing. The controller 10 starts swipe-event processing when a swipe-event occurs.

In step S31, the controller 10 acquires the direction in which a swipe operation has been performed. In step S32, the controller 10 determines a page to be displayed, in accordance with the direction acquired in step S31. In step S33, the controller 10 issues a page-turn command.

In steps S34 to S37, when there is a bookmark candidate, the controller 10 determines the bookmark candidate to be a bookmark. That is, when the number of bookmark candidates is one or more (YES in step S34), the procedure proceeds to S35. In step S35, the controller 10 registers the bookmark candidates as bookmarks. That is, the controller 10 stores bookmark information in the bookmark database. In step S36, the controller 10 sets the bookmark-candidate counter to zero. In step S37, the controller 10 sets a bookmark counter to the number of registered bookmarks.

After registration of the bookmarks is completed in steps S35 to S37 or when the number of bookmark candidates is zero (NO in step S34), the controller 10 ends the swipe-event processing.

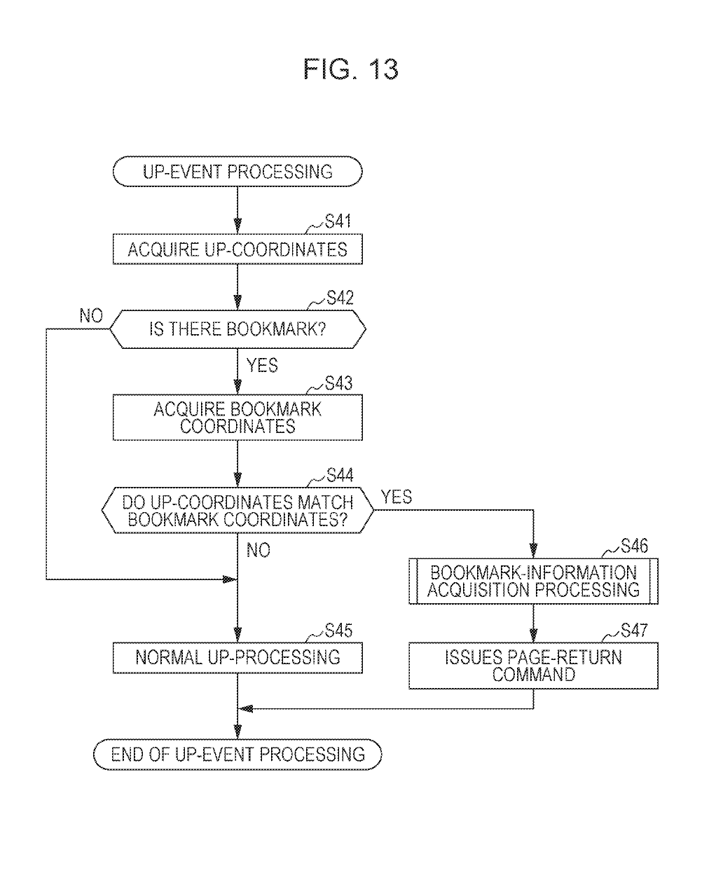

FIG. 13 is a diagram illustrating an example of operation of the information processing apparatus 1 to describe up-event processing. The controller 10 starts up-event processing when an up-event occurs.

In step S41, the controller 10 acquires up-coordinates that represent a position at which a touch ends. In step S42, the controller 10 determines whether or not there is a bookmark. That is, the controller 10 determines whether or not bookmark information has been stored in the bookmark database.

When there is a bookmark (YES in step S42), the procedure proceeds to step S43. In step S43, the controller 10 acquires bookmark coordinates from the bookmark database. In step S44, the controller 10 determines whether the up-coordinates match the bookmark coordinates.

When there is no bookmark (NO in step S42) or when the up-coordinates do not match the bookmark coordinates (NO in step S44), the procedure proceeds to step S45. In step S45, the controller 10 executes normal up-processing. Normal up-processing is processing in which, for example, a hold operation preformed for a page object displayed on the screen 21 is canceled.

When the up-coordinates match the bookmark coordinates (YES in step S44), the controller 10 starts bookmark-information acquisition processing, which will be described below in step S46. Thereafter, in step S47, the controller 10 issues a page-return command. A page-return command is a command to make the display target of the screen 21 return to a page object 6 specified by bookmark information. Then, the up-event processing ends.

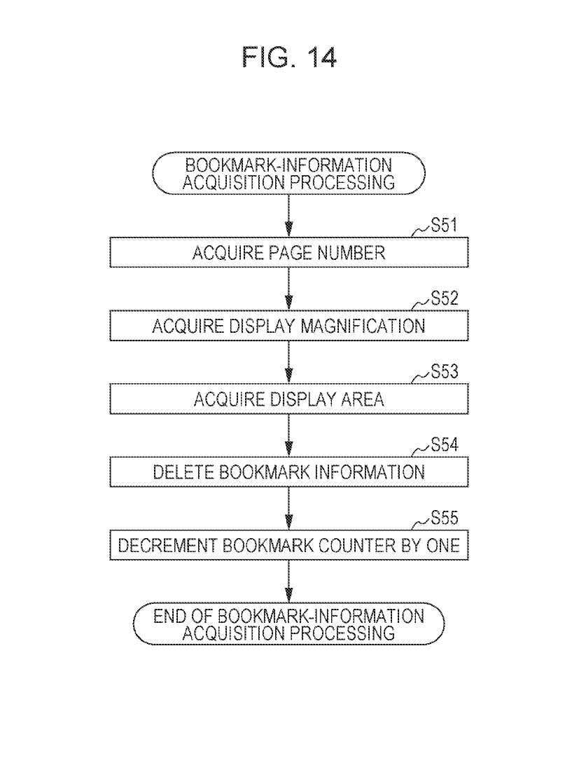

FIG. 14 is a diagram illustrating an example of operation of the information processing apparatus 1 to describe bookmark-information acquisition processing. The controller 10 starts bookmark-information acquisition processing in step S46 of the above-described up-event processing.

In steps S51 to S53, the controller 10 acquires, from the bookmark database, bookmark information that includes bookmark coordinates that match the up-coordinates. That is, in step S51, the controller 10 acquires the page number included in the bookmark information. In step S52, the controller 10 acquires the display magnification included in the bookmark information. In step S53, the controller 10 acquires the display area included in the bookmark information.

In step S54, the controller 10 deletes the acquired bookmark information from the bookmark database. In step S55, the controller 10 decrements the bookmark counter by one. Then, the bookmark-information acquisition processing ends.

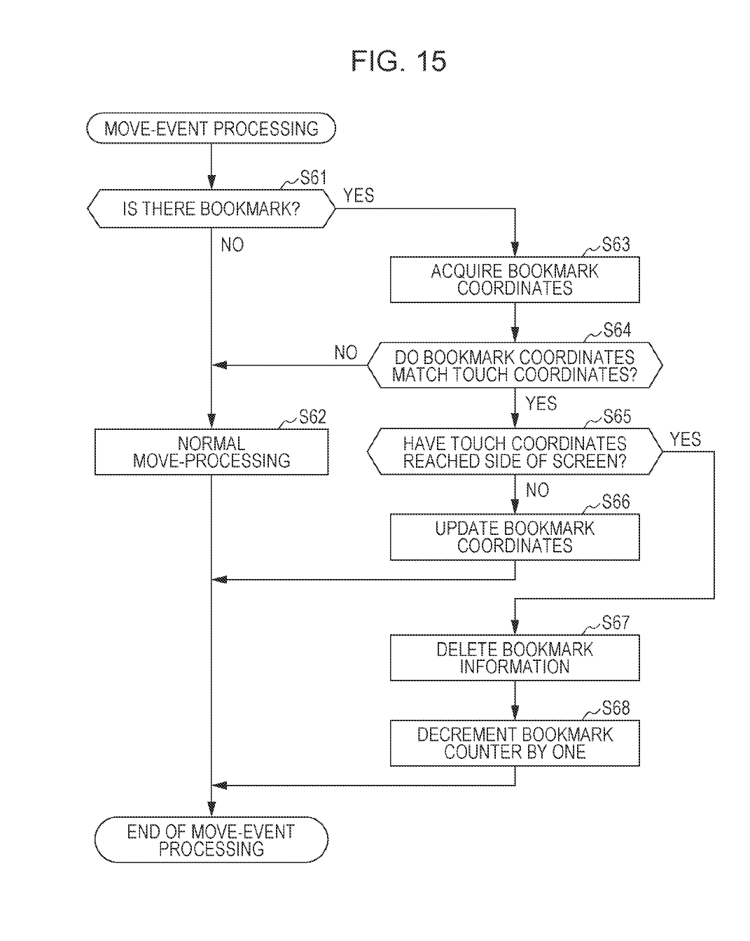

FIG. 15 is a diagram illustrating an example of operation of the information processing apparatus 1 to describe move-event processing. The controller 10 starts move-event processing when a move event occurs.

In step S61, the controller 10 determines whether or not there is a bookmark. That is, the controller 10 determines whether or not bookmark information has been stored in the bookmark database. When there is a bookmark (YES in step S61), the procedure proceeds to step S63. In step S63, the controller 10 acquires bookmark coordinates from the bookmark database. In step S64, the controller 10 determines whether the bookmark coordinates match the touch coordinates.

When there is no bookmark (NO in step S61) or when the bookmark coordinates do not match the touch coordinates (NO in step S64), the procedure proceeds to step S62. In step S62, the controller 10 executes normal move-processing. Normal move-processing is processing such as scrolling performed for the area displayed on the screen 21 or the like.

When the bookmark coordinates match the touch coordinates (YES in step S64), the procedure proceeds to step S65. In step S65, the controller 10 determines whether or not the touch coordinates have reached a side of the screen 21. When the touch coordinates have not reached a side of the screen 21 (NO in step S65), the procedure proceeds to step S66. In step S66, the controller 10 stores the touch coordinates obtained after the touch coordinates have moved, as the bookmark coordinates in the bookmark database.

When the touch coordinates have reached a side of the screen 21 (YES in step S65), the controller 10 deletes the bookmark information in step S67 and decrements the bookmark counter by one in step S68.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display;
a detector that detects a touch of a finger on a screen of the display;
a display controller that makes a page image selected from a plurality of page images be displayed on the screen and that executes, upon receiving a page switch command, page switch processing in which a page image displayed on the screen is switched to another page image;
a bookmark-information generation unit that generates, in a case where the page switch processing is executed in a state in which a touch of the finger is being detected on the screen on which a page image is displayed, bookmark information that includes identification information of the page image, which is displayed on the screen before execution of the page switch processing; and
a switch command generation unit that generates a page switch command used to switch a page image displayed on the screen to a page image specified by the bookmark information in a case where the touch of the finger is no longer detected.

2. The information processing apparatus according to claim 1,
wherein the bookmark information includes magnification information that indicates a magnification of the page image, which is displayed on the screen before execution of the page switch processing, and
wherein the display controller makes the page image specified by the bookmark information be displayed at the magnification specified by the magnification information.

3. The information processing apparatus according to claim 1,
wherein the bookmark information includes area information that indicates a display area of the page image, which is displayed on the screen before execution of the page switch processing, and
wherein the display controller makes the display area of the page image specified by the bookmark information be displayed, the display area being specified by the area information.

4. The information processing apparatus according to claim 1, further comprising a bookmark-information update unit that deletes the bookmark information in a case where the touch has moved to a predetermined position.

5. The information processing apparatus according to claim 1,
wherein the display controller makes information regarding the page image specified by the bookmark information be displayed, in a case where a distance by which the touch has moved has reached a predetermined distance.

6. The information processing apparatus according to claim 1,
wherein the bookmark information includes coordinate information that indicates position coordinates of the touch, and
wherein the information processing apparatus further comprises a bookmark-information update unit that updates coordinate information included in the bookmark information in a case where the touch has moved.

7. An information processing apparatus comprising:
a display;
a detector that detects a touch of a finger on a screen of the display;
a display controller that makes a page image selected from a plurality of page images be displayed on the screen and that executes, upon receiving a page switch command, page switch processing in which a page image displayed on the screen is switched to another page image;
a bookmark-information generation unit that generates, in a case where a touch of the finger, the touch being performed on the screen, satisfies a predetermined condition in a state in which a page image is being displayed, bookmark information that includes identification information of the page image, which is being displayed on the screen; and
a switch command generation unit that generates a page switch command used to switch a page image displayed on the screen to a page image specified by the bookmark information in a case where the touch of the finger is no longer detected.

8. A non-transitory computer readable medium storing a program causing a computer to execute a process, the computer including a display device and a touch detector that detects a touch performed on a screen of the display device, the process comprising:
upon receiving a page switch command, executing page switch processing in which a page image displayed on the screen is switched to another page image, which is a page image selected from a plurality of page images;
generating bookmark information that includes identification information of a page image that is displayed on the screen before execution of the page switch processing, in a case where the page switch processing is executed in a state in which a touch is being detected; and
generating a page switch command used to switch a page image displayed on the screen to a page image specified by the bookmark information in a case where the touch is no longer detected.

9. A non-transitory computer readable medium storing a program causing a computer to execute a process, the computer including a display device and a touch detector that detects a touch performed on a screen of the display device, the process comprising:
upon receiving a page switch command, executing page switch processing in which a page image displayed on the screen is switched to another page image, which is a page image selected from a plurality of page images;
generating bookmark information that includes identification information of a page image that is being displayed on the screen, in a case where the touch satisfies a predetermined condition; and
generating a page switch command used to switch a page image displayed on the screen to a page image specified by the bookmark information in a case where the touch is no longer detected.

10. An information processing apparatus comprising:
a touch screen that detects a plurality of positions touched by fingers;
a display controller that makes document data be displayed on the touch screen, the document data including a plurality of page images, and that detects a swipe operation performed by a finger on the touch screen on which a page image of the document data is displayed and executes page switch processing in which the page image, which is displayed on the touch screen, is switched to another page image; and
a bookmark-information generation unit that generates, in a case where the page switch processing is executed in a state in which a touch of another finger is being detected on the touch screen on which a page image is displayed, bookmark information that includes identification information of the page image, which is displayed on the touch screen before execution of the page switch processing,
wherein the display controller further executes control in which a page image displayed on the touch screen is switched to a page image specified by the bookmark information in a case where the touch of the other finger is no longer detected on the touch screen.

11. An information processing apparatus comprising:
a touch screen that detects a plurality of positions touched by fingers;
a display controller that makes document data be displayed on the touch screen, the document data including a plurality of page images, and that detects a swipe operation performed by a finger on the touch screen on which a page image of the document data is displayed and executes page switch processing in which the page image, which is displayed on the touch screen, is switched to another page image; and
a bookmark-information generation unit that generates, in a case where another finger is touching the touch screen on which a page image is displayed, for a predetermined time period or longer or in a case where the other finger is touching at a predetermined position on the page image, bookmark information that includes identification information of the page image, which is being displayed on the touch screen,
wherein the display controller further executes control in which a page image displayed on the touch screen is switched to a page image specified by the bookmark information in a case where the touch of the other finger is no longer detected on the touch screen.

12. An information processing method for an information processing apparatus that includes a display, the information processing method comprising:
detecting a touch of a finger on a screen of the display;
making a page image selected from a plurality of page images be displayed on the screen and executing, upon receiving a page switch command, page switch processing in which a page image displayed on the screen is switched to another page image;
generating, in a case where the page switch processing is executed in a state in which a touch of the finger is being detected on the screen on which a page image is displayed, bookmark information that includes identification information of the page image, which is displayed on the screen before execution of the page switch processing; and
generating a page switch command used to switch a page image displayed on the screen to a page image specified by the bookmark information in a case where the touch of the finger is no longer detected.
